(19) United States
(12) Patent Application Publication
(10) Pub. No.: US 2003/0084870 A1
(43) Pub. Date: May 8, 2003

(54) Large volume flow-homogenizing fuel injection nozzle and system and method incorporating same

(76) Inventor: Scott E. Parrish, Farmington Hills, MI (US)

Correspondence Address: Tait R. Swanson, Fletcher, Yoder & Van Someren, P.O. Box 692289, Houston, TX, 77269-2289, US

(21) Appl. No.: 10/005,838

(22) Filed: Nov. 8, 2001

(51) Int. Cl. F02B 5/00

(52) U.S. Cl. 123/305; 239/533.7

(57) ABSTRACT

A technique is provided for homogenizing fluid flow in an outwardly opening nozzle assembly. A cavity is provided in a fluid flow passage adjacent a spray exit of an outwardly opening poppet to dampen fluid flow variances prior to spray formation at the spray exit. Accordingly, the spray formed at the spray exit has a substantially uniform distribution of fluid droplets.

### BACKGROUND OF THE INVENTION

1. Field of the Invention

The present invention relates generally to the field of internal combustion engine injection systems. More particularly, the invention relates to a technique for dampening flow variances through a spray assembly and for providing a relatively uniform spray pattern by providing a relatively large flow cavity near the spray exit.

2. Description of the Related Art

In fuel-injected engines, it is generally considered desirable that each injector delivers approximately the same quantity of fuel in approximately the same temporal relationship to the engine for proper operation. It is also well known that the fuel-air mixture affects the combustion process and the formation of pollutants, such as Sulfur Oxides, Nitrogen Oxides, Hydrocarbons, and particulate matter. Although combustion engines utilize a variety of mixing techniques to improve the fuel-air mixture, many combustion engines rely heavily on spray assemblies to disperse fuel throughout a combustion chamber. These spray assemblies may produce a variety of spray patterns, such as a hollow or solid conical spray pattern, which affect the overall fuel-air mixture in the combustion chamber. It is generally desirable to provide a uniform fuel-air mixture to optimize the combustion process and to eliminate pollutants. However, conventional combustion engines continue to operate inefficiently and produce pollutants due to poor fuel-air mixing in the combustion chamber.

Accordingly, the present technique provides various unique features to overcome the disadvantages of existing spray systems and to improve the fuel-air mixture in combustion engines. In particular, unique features are provided to enhance the fluid flow through an outwardly opening nozzle assembly to provide desired spray characteristics.

### SUMMARY OF THE INVENTION

The present technique offers a design for internal combustion engines that contemplates such needs. The technique is applicable to a variety of fuel injection systems, and is particularly well suited to pressure pulsed designs, in which fuel is pressurized for injection into a combustion chamber by a reciprocating electric motor and pump. However, other injection system types may benefit from the technique described herein, including those in which fuel and air are admitted into a combustion chamber in mixture. The present technique provides a cavity in a fluid flow passage adjacent a spray exit of an outwardly opening poppet to dampen fluid flow variance prior to spray formation at the spray exit. Accordingly, the spray formed at the spray exit has a substantially uniform distribution of fluid droplets.

In one aspect, the present technique comprises a nozzle comprising a conduit having an inlet and an exit, and an outwardly opening poppet movably disposed in the conduit. The outwardly opening poppet includes a first section adjacent the inlet and forming a first cavity between the poppet and the conduit. A second section is also provided adjacent the exit. The second section forms a second cavity between the poppet and the conduit, wherein the second cavity has a large volume geometry configured for dampening fluid flow variances. In this configuration, the nozzle also includes a guide section disposed between the first and second sections and having at least one passageway coupling the first and second cavities.

In another aspect, the present technique provides a method for homogenizing a spray from an outwardly opening nozzle assembly. The method comprises passing fluid through a flow homogenizing chamber of an outwardly opening nozzle assembly to dampen fluid flow variances and provide a substantially uniform spray.

### BRIEF DESCRIPTION OF THE DRAWINGS

The foregoing and other advantages of the invention will become apparent upon reading the following detailed description and upon reference to the drawings in which:

FIG. 1 is a side view of a marine propulsion device embodying an outboard drive or propulsion unit adapted for mounting to a transom of a watercraft;

FIG. 2 is a cross-sectional view of the combustion engine;

FIG. 3 is a diagrammatical representation of a series of fluid pump assemblies applied to inject fuel into an internal combustion engine;

FIG. 4 is a partial cross-sectional view of an exemplary pump in accordance with aspects of the present technique for use in displacing fluid under pressure, such as for fuel injection into a chamber of an internal combustion engine as shown in FIG. 3;

FIG. 5 is a partial cross-sectional view of the pump illustrated in FIG. 4 energized to an open position during a pumping phase of operation;

FIG. 6 is a partial cross-sectional view of an exemplary nozzle assembly in a closed position, as illustrated in FIG. 4;

FIG. 7 is a partial cross-sectional view of the nozzle assembly in the open position, as illustrated in FIG. 5;

FIG. 8 is a cross-sectional view of an exemplary hollow spray formed by the nozzle assembly illustrated in FIG. 7; and

FIG. 9 is a cross-sectional view of the hollow spray illustrated in FIG. 8.

### DETAILED DESCRIPTION OF SPECIFIC EMBODIMENTS

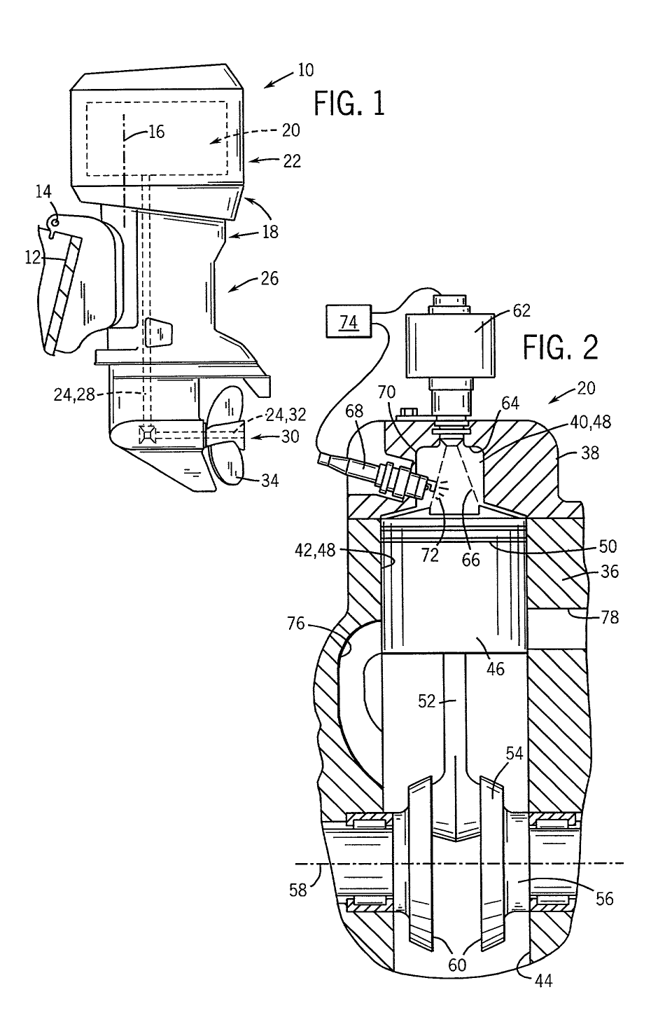

The present technique will be described with respect to a 2-cycle outboard marine engine as illustrated in FIGS. 1-2. However, it will be appreciated that this invention is equally applicable for use with a 4-cycle engine, a diesel engine, or any other type of internal combustion engine having at least one fuel injector, which may have one or more geometrically varying fluid passageways leading to a nozzle exit. The present technique is also applicable in other applications utilizing fluid spray assemblies, such as a nozzle producing a hollow or solid cone-shaped droplet spray.

FIG. 1 is a side view of a marine propulsion device embodying an outboard drive or propulsion unit 10 adapted to be mounted on a transom 12 of a watercraft for pivotal tilting movement about a generally horizontal tilt axis 14 and for pivotal steering movement about a generally upright steering axis 16. The drive or propulsion unit 10 has a housing 18, wherein a fuel-injected, two-stroke internal combustion engine 20 is disposed in an upper section 22 and a transmission assembly 24 is disposed in a lower section 26. The transmission assembly 24 has a drive shaft 28 drivingly coupled to the combustion engine 20, and extending longitudinally through the lower section 26 to a propulsion region 30 whereat the drive shaft 28 is drivingly coupled to a propeller shaft 32. Finally, the propeller shaft 32 is drivingly coupled to a prop 34 for rotating the prop 34, thereby creating a thrust force in a body of water. In the present technique, the combustion engine 20 may embody a four-cylinder or six-cylinder V-type engine for marine applications, or it may embody a variety of other combustion engines with a suitable design for a desired application, such as automotive, industrial, etc.

FIG. 2 is a cross-sectional view of the combustion engine 20. For illustration purposes, the combustion engine 20 is illustrated as a two-stroke, direct-injected, internal combustion engine having a single piston and cylinder. As illustrated, the combustion engine 20 has an engine block 36 and a head 38 coupled together and defining a firing chamber 40 in the head 38, a piston cylinder 42 in the engine block 36 adjacent to the firing chamber 40, and a crankcase chamber 44 in the engine block 36 adjacent to the piston cylinder 42. A piston 46 is slidably disposed in the piston cylinder 42, and defines a combustion chamber 48 adjacent to the firing chamber 40. A ring 50 is disposed about the piston 46 for providing a sealing force between the piston 46 and the piston cylinder 42. A connecting rod 52 is pivotally coupled to the piston 46 on a side opposite from the combustion chamber 48, and the connecting rod 52 is also pivotally coupled to an outer portion 54 of a crankshaft 56 for rotating the crankshaft 56 about an axis 58. The crankshaft 56 is rotatably coupled to the crankcase chamber 44, and preferably has counterweights 60 opposite from the outer portion 54 with respect to the axis 58.

In general, an internal combustion engine such as engine 20 operates by compressing and igniting a fuel-air mixture. In some combustion engines, fuel is injected into an air intake manifold, and then the fuel-air mixture is injected into the firing chamber for compression and ignition. As described below, the illustrated embodiment intakes only the air, followed by direct fuel injection and then ignition in the firing chamber.

A fuel injection system, having a fuel injector 62 disposed in a first portion 64 of the head 38, is provided for directly injecting a fuel spray 66 into the firing chamber 40. An ignition assembly, having a spark plug 68 disposed in a second portion 70 of the head 38, is provided for creating a spark 72 to ignite the fuel-air mixture compressed within the firing chamber 40. The control and timing of the fuel injector 62 and the spark plug 68 are critical to the performance of the combustion engine 20. Accordingly, the fuel injection system and the ignition assembly are coupled to a control assembly 74. As discussed in further detail below, the uniformity of the fuel spray 66 is also critical to performance of the combustion engine 20. The distribution of fuel spray 66 affects the combustion process, the formation of pollutants and various other factors.

In operation, the piston 46 linearly moves between a bottom dead center position (not illustrated) and a top dead center position (as illustrated in FIG. 2), thereby rotating the crankshaft 56 in the process of the linear movement. At bottom dead center, an intake passage 76 couples the combustion chamber 48 to the crankcase chamber 44, allowing air to flow from the crankcase chamber 44 below the piston 46 to the combustion chamber 48 above the piston 46. The piston 46 then moves linearly upward from bottom dead center to top dead center, thereby closing the intake passage 76 and compressing the air into the firing chamber 40. At some point, determined by the control assembly 74, the fuel injection system is engaged to trigger the fuel injector 62, and the ignition assembly is engaged to trigger the spark plug 68. Accordingly, the fuel-air mixture combusts and expands from the firing chamber 40 into the combustion chamber 48, and the piston 46 is forced downwardly toward bottom dead center. This downward motion is conveyed to the crankshaft 56 by the connecting rod 52 to produce a rotational motion of the crankshaft 56, which is then conveyed to the prop 34 by the transmission assembly 24 (as illustrated in FIG. 1). Near bottom dead center, the combusted fuel-air mixture is exhausted from the piston cylinder 42 through an exhaust passage 78. The combustion process then repeats itself as the cylinder is charged by air through the intake passage 76.

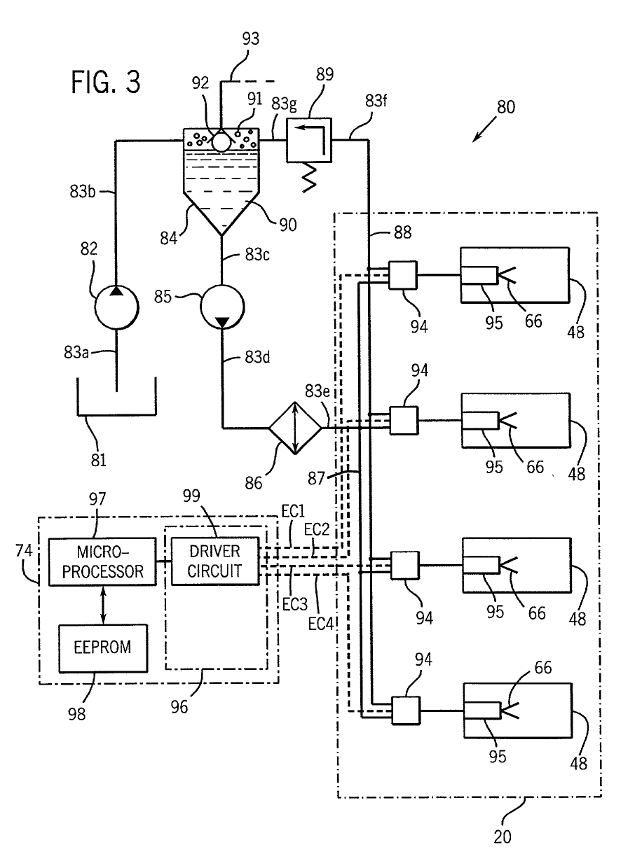

Referring now to FIG. 3, the fuel injection system 80 is diagrammatically illustrated as having a series of pumps for displacing fuel under pressure in the internal combustion engine 20. While the fluid pumps of the present technique may be employed in a wide variety of settings, they are particularly well suited to fuel injection systems in which relatively small quantities of fuel are pressurized cyclically to inject the fuel into combustion chambers of an engine as a function of the engine demands. The pumps may be employed with individual combustion chambers as in the illustrated embodiment, or may be associated in various ways to pressurize quantities of fuel, as in a fuel rail, feed manifold, and so forth. Even more generally, the present pumping technique may be employed in settings other than fuel injection, such as for displacing fluids under pressure in response to electrical control signals used to energize coils of a drive assembly, as described below. Moreover, the system 80 and engine 20 may be used in any appropriate setting, and are particularly well suited to two-stroke applications such as marine propulsion, outboard motors, motorcycles, scooters, snowmobiles and other vehicles.

In the exemplary embodiment shown in FIG. 3, the fuel injection system 80 has a fuel reservoir 81, such as a tank for containing a reserve of liquid fuel. A first pump 82 draws the fuel from the reservoir 81 through a first fuel line 83a, and delivers the fuel through a second fuel line 83b to a separator 84. While the system may function adequately without a separator 84, in the illustrated embodiment, separator 84 serves to insure that the fuel injection system downstream receives liquid fuel, as opposed to mixed phase fuel. A second pump 85 draws the liquid fuel from separator 84 through a third fuel line 83c and delivers the fuel, through a fourth fuel line 83d and further through a cooler 86, to a feed or inlet manifold 87 through a fifth fuel line 83e. Cooler 86 may be any suitable type of fluid cooler, including both air and liquid heater exchangers, radiators, and the like.

Fuel from the feed manifold 87 is available for injection into combustion chambers of engine 20, as described more fully below. A return manifold 88 is provided for recirculating fluid not injected into the combustion chambers of the engine. In the illustrated embodiment a pressure regulating valve 89 is coupled to the return manifold 88 through a sixth fuel line 83f and is used for maintaining a desired pressure within the return manifold 88. Fluid returned via the pressure regulating valve 89 is recirculated into the separator 84 through a seventh fuel line 83g where the fuel collects in liquid phase as illustrated at reference numeral 90. Gaseous phase components of the fuel, designated by referenced numeral 91 in FIG. 3, may rise from the fuel surface and, depending upon the level of liquid fuel within the separator, may be allowed to escape via a float valve 92. The float valve 92 consists of a float that operates a ventilation valve coupled to a ventilation line 93. The ventilation line 93 is provided for permitting the escape of gaseous components, such as for repressurization, recirculation, and so forth. The float rides on the liquid fuel 90 in the separator 84 and regulates the ventilation valve based on the level of the liquid fuel 90 and the presence of vapor in the separator 84.

As illustrated in FIG. 3, engine 20 may include a series of combustion chambers 48 for collectively driving the crankshaft 56 in rotation. As discussed with reference to FIG. 2, the combustion chambers 48 comprise the space adjacent to a series of pistons 46 disposed in piston cylinders 42. As will be appreciated by those skilled in the art, and depending upon the engine design, the pistons 46 (FIG. 2) are driven in a reciprocating fashion within each piston cylinder 42 in response to ignition, combustion and expansion of the fuel-air mixture within each combustion chamber 48. The stroke of the piston within the chamber will permit fresh air for subsequent combustion cycles to be admitted into the chamber, while scavenging combustion products from the chamber. While the present embodiment employs a straightforward two-stroke engine design, the pumps in accordance with the present technique may be adapted for a wide variety of applications and engine designs, including other than two-stroke engines and cycles.

In the illustrated embodiment, the fuel injection system 80 has a reciprocating pump 94 associated with each combustion chamber 48, each pump 94 drawing pressurized fuel from the feed manifold 87, and further pressurizing the fuel for injection into the respective combustion chamber 48. In this exemplary embodiment, the fuel injector 62 (FIG. 2) may have a nozzle 95 (FIG. 3) for atomizing the pressurized fuel downstream of each reciprocating pump 94. While the present technique is not intended to be limited to any particular injection system or injection scheme, in the illustrated embodiment, a pressure pulse created in the liquid fuel forces the fuel spray 66 to be formed at the mouth or outlet of the nozzle 95, for direct, in-cylinder injection. The operation of reciprocating pumps 94 is controlled by an injection controller 96 of the control assembly 74. The injection controller 96, which will typically include a programmed microprocessor or other digital processing circuitry and memory for storing a routine employed in providing control signals to the pumps, applies energizing signals to the pumps to cause their reciprocation in any one of a wide variety of manners as described more fully below.

The control assembly 74 and/or the injection controller 96 may have a processor 97 or other digital processing circuitry, a memory device 98 such as EEPROM for storing a routine employed in providing command signals from the processor 97, and a driver circuit 99 for processing commands or signals from the processor 97. The control assembly 74 and the injection controller 96 may utilize the same processor 97 and memory as illustrated in FIG. 3, or the injection controller 96 may have a separate processor and memory device. The driver circuit 99 may be constructed with multiple circuits or channels, each individual channel corresponding with a reciprocating pump 94. In operation, a command signal may be passed from the processor 97 to the driver circuit 99, which responds by generating separate drive signals for each channel. These signals are carried to each individual pump 94 as represented by individual electric connections EC1, EC2, EC3 and EC4. Each of these connections corresponds with a channel of the driver circuit 99. The operation and logic of the control assembly 74 and injection controller 96 will be discussed in greater detail below.

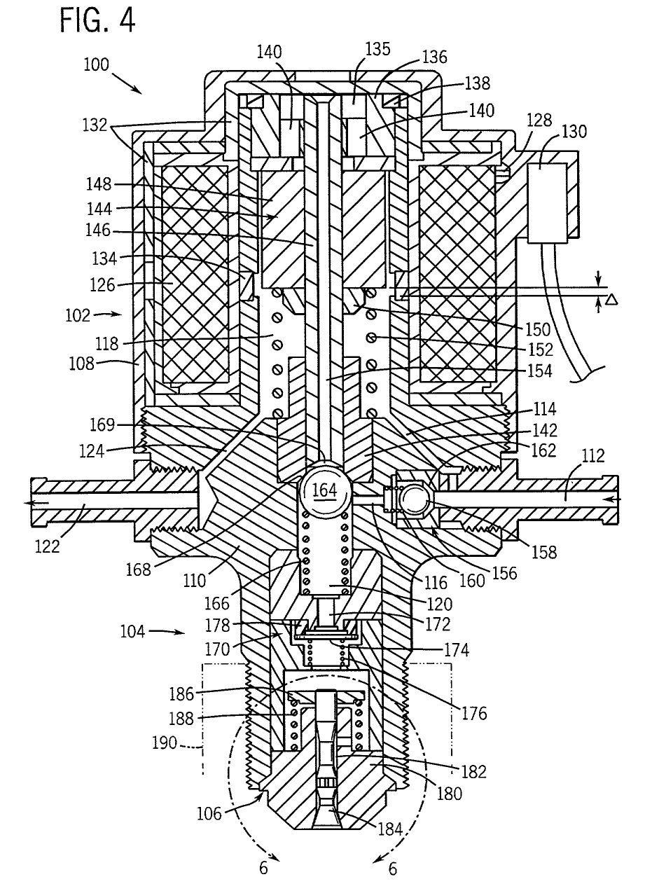

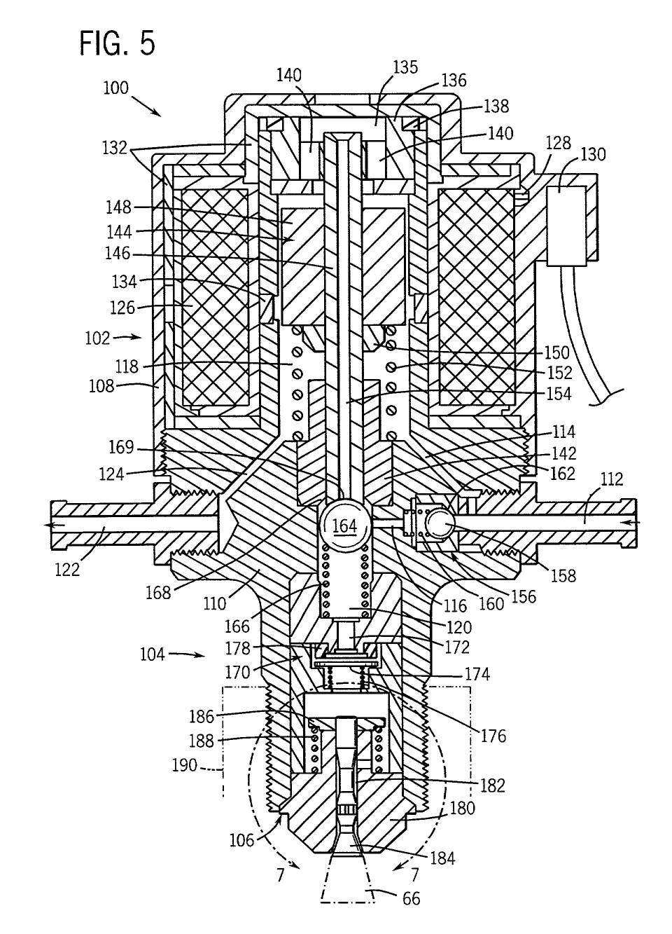

Specifically, FIG. 4 illustrates the internal components of a pump assembly including a drive section and a pumping section in a first position wherein fuel is introduced into the pump for pressurization. FIG. 5 illustrates the same pump following energization of a solenoid coil to drive a reciprocating assembly and thus cause pressurization of the fuel and its expulsion from the pump. It should be borne in mind that the particular configurations illustrated in FIGS. 4 and 5 are intended to be exemplary only. Other variations on the pump may be envisaged, particularly variants on the components used to pressurize the fluid and to deliver the fluid to a downstream application.

In the presently contemplated embodiment, a pump and nozzle assembly 100, as illustrated in FIGS. 4 and 5, is particularly well suited for application in an internal combustion engine, as illustrated in FIGS. 1-3. Moreover, in the embodiment illustrated in FIGS. 4 and 5, a nozzle assembly is installed directly at an outlet of a pump section, such that the pump 94 and the nozzle 95 of FIG. 3 are incorporated into a single assembly 100. As indicated above, in appropriate applications, the pump 94 may be separated from the nozzle 95, such as for application of fluid under pressure to a manifold, fuel rail, or other downstream component. Thus, the fuel injector 62 described with reference to FIG. 2 may comprise the nozzle 95, the pump and nozzle assembly 100, or other designs and configurations capable of fuel injection.

Referring to FIG. 4, an embodiment is shown wherein the fluid actuators and fuel injectors are combined into a single unit, or pump-nozzle assembly 100. The pump-nozzle assembly 100 is composed of three primary subassemblies: a drive section 102, a pump section 104, and a nozzle 106. The drive section 102 is contained within a solenoid housing 108. A pump housing 110 serves as the base for the pump-nozzle assembly 100. The pump housing 110 is attached to the solenoid housing 108 at one end and to the nozzle 106 at an opposite end.

There are several flow paths for fuel within pump-nozzle assembly 100. Initially, fuel enters the pump-nozzle assembly 100 through the fuel inlet 112. Fuel can flow from the fuel inlet 112 through two flow passages, a first passageway 114 and a second passageway 116. A portion of fuel flows through the first passageway 114 into an armature chamber 118. For pumping, fuel also flows through the second passageway 116 to a pump chamber 120. Heat and vapor bubbles are carried from the armature chamber 118 by fuel flowing to an outlet 122 through a third fluid passageway 124. Fuel then flows from the outlet 122 to the return manifold 88 (see FIG. 3).

The drive section 102 incorporates a linear electric motor. In the illustrated embodiment, the linear electric motor is a reluctance gap device. In the present context, reluctance is the opposition of a magnetic circuit to the establishment or flow of a magnetic flux. A magnetic field and circuit are produced in the motor by electric current flowing through a coil 126. The coil 126 is electrically coupled by leads 128 to a receptacle 130, which is coupled by conductors (not shown) to an injection controller 96 of the control assembly 74. Magnetic flux flows in a magnetic circuit 132 around the exterior of the coil 126 when the coil is energized. The magnetic circuit 132 is composed of a material with a low reluctance, typically a magnetic material, such as ferromagnetic alloy, or other magnetically conductive materials. A gap in the magnetic circuit 132 is formed by a reluctance gap spacer 134 composed of a material with a relatively higher reluctance than the magnetic circuit 132, such as synthetic plastic.

A reciprocating assembly 144 forms the linear moving elements of the reluctance motor. The reciprocating assembly 144 includes a guide tube 146, an armature 148, a centering element 150 and a spring 152. The guide tube 146 is supported at the upper end of travel by the upper bushing 136 and at the lower end of travel by the lower bushing 142. An armature 148 is attached to the guide tube 146. The armature 148 sits atop a biasing spring 152 that opposes the downward motion of the armature 148 and guide tube 146, and maintains the guide tube and armature in an upwardly biased or retracted position. Centering element 150 keeps the spring 152 and armature 148 in proper centered alignment. The guide tube 146 has a central passageway 154, which permits the flow of a small volume of fuel when the guide tube 146 moves a given distance through the armature chamber 118 as described below. Accordingly, the flow of fuel through the central passageway 154 facilitates cooling and acceleration of the guide tube 146, which is moved in response to energizing the coil during operation.

When the coil 126 is energized, the magnetic flux field produced by the coil 126 seeks the path of least reluctance. The armature 148 and the magnetic circuit 132 are composed of a material of relatively low reluctance. The magnetic flux lines will thus extend around coil 126 and through magnetic circuit 132 until the magnetic gap spacer 134 is reached. The magnetic flux lines will then extend to armature 148 and an electromagnetic force will be produced to drive the armature 148 downward towards the reluctance gap spacer 134. When the flow of electric current is removed from the coil by the injection controller 96, the magnetic flux will collapse and the force of spring 152 will drive the armature 148 upwardly and away from alignment with the reluctance gap spacer 134. Cycling the electrical control signals provided to the coil 126 produces a reciprocating linear motion of the armature 148 and guide tube 146 by the upward force of the spring 152 and the downward force produced by the magnetic flux field on the armature 148.

During the return motion of the reciprocating assembly 144 a fluid brake within the pump-nozzle assembly 100 acts to slow the upward motion of the moving portions of the drive section 102. The upper portion of the solenoid housing 108 is shaped to form a recessed cavity 135. An upper bushing 136 separates the recessed cavity 135 from the armature chamber 118 and provides support for the moving elements of the drive section at the upper end of travel. A seal 138 is located between the upper bushing 136 and the solenoid housing 108 to ensure that the only flow of fuel from the armature chamber 118 to and from the recessed cavity 135 is through fluid passages 140 in the upper bushing 136. In operation, the moving portions of the drive section 102 will displace fuel from the armature chamber 118 into the recessed cavity 135 during the period of upward motion. The flow of fuel is restricted through the fluid passageways 140, thus, acting as a brake on upward motion. A lower bushing 142 is included to provide support for the moving elements of the drive section at the lower travel limit and to seal the pump section from the drive section.

While the first fuel flow path 114 provides proper dampening for the reciprocating assembly as well as providing heat transfer benefits, the second fuel flow path 116 provides the fuel for pumping and, ultimately, for combustion. The drive section 102 provides the motive force to drive the pump section 104, which produces a surge of pressure that forces fuel through the nozzle 106. As described above, the drive section 102 operates cyclically to produce a reciprocating linear motion in the guide tube 146. During a charging phase of the cycle, fuel is drawn into the pump section 104. Subsequently, during a discharging phase of the cycle, the pump section 104 pressurizes the fuel and discharges the fuel through the nozzle 106, such as directly into the combustion chamber 48 (see FIG. 3).

During the charging phase fuel enters the pump section 104 from the inlet 112 through an inlet check valve assembly 156. The inlet check valve assembly 156 contains a ball 158 biased by a spring 160 toward a seat 162. During the charging phase the pressure of the fuel in the fuel inlet 112 will overcome the spring force and unseat the ball 158. Fuel will flow around the ball 158 and through the second passageway 116 into the pump chamber 120. During the discharging phase the pressurized fuel in the pump chamber 120 will assist the spring 160 in seating the ball 158, preventing any reverse flow through the inlet check valve assembly 156.

A pressure surge is produced in the pump section 104 when the guide tube 146 drives a pump sealing member 164 into the pump chamber 120. The pump sealing member 164 is held in a biased position by a spring 166 against a stop 168. The force of the spring 166 opposes the motion of the pump sealing member 164 into the pump chamber 120. When the coil 126 is energized to drive the armature 148 towards alignment with the reluctance gap spacer 134, the guide tube 146 is driven towards the pump sealing member 164. There is, initially, a gap 169 between the guide tube 146 and the pump sealing member 164. Until the guide tube 146 transits the gap 169 there is essentially no increase in the fuel pressure within the pump chamber 120, and the guide tube and armature are free to gain momentum by flow of fuel through passageway 154. The acceleration of the guide tube 146 as it transits the gap 169 produces the rapid initial surge in fuel pressure once the guide tube 146 contacts the pump sealing member 164, which seals passageway 154 to pressurize the volume of fuel within the pump chamber 120.

Referring generally to FIG. 5, a seal is formed between the guide tube 146 and the pump sealing member 164 when the guide tube 146 contacts the pump sealing member 164. This seal closes the opening to the central passageway 154 from the pump chamber 120. The electromagnetic force driving the armature 148 and guide tube 146 overcomes the force of springs 152 and 166, and drives the pump sealing member 164 into the pump chamber 120. This extension of the guide tube into the pump chamber 120 causes an increase in fuel pressure in the pump chamber 120 that, in turn, causes the inlet check valve assembly 156 to seat, thus stopping the flow of fuel into the pump chamber 120 and ending the charging phase. The volume of the pump chamber 120 will decrease as the guide tube 146 is driven into the pump chamber 120, further increasing pressure within the pump chamber 120 and forcing displacement of the fuel from the pump chamber 120 to the nozzle 106 through an outlet check valve assembly 170. The fuel displacement will continue as the guide tube 146 is progressively driven into the pump chamber 120.

Pressurized fuel flows from the pump chamber 120 through a passageway 172 to the outlet check valve assembly 170. The outlet check valve assembly 170 includes a valve disc 174, a spring 176 and a seat 178. The spring 176 provides a force to seat the valve disc 174 against the seat 178. Fuel flows through the outlet check valve assembly 170 when the force on the pump chamber side of the valve disc 174 produced by the rise in pressure within the pump chamber 120 is greater than the force placed on the outlet side of the valve disc 174 by the spring 176 and any residual pressure within the nozzle 106.

Once the pressure in the pump chamber 120 has risen sufficiently to open the outlet check valve assembly 170, fuel will flow from the pump chamber 120 to the nozzle 106. The nozzle 106 is comprised of a nozzle housing 180 having a central passage 182, a poppet 184 movably disposed in the central passage 182, a retainer 186, and a spring 188. The retainer 186 is attached to the poppet 184, and spring 188 applies an upward force on the retainer 186 that acts to hold the poppet 184 seated against the nozzle housing 180. A volume of fuel is retained within the nozzle 106 when the poppet 184 is seated. The pressurized fuel flowing into the nozzle 106 from the outlet check valve assembly 170 pressurizes this retained volume of fuel. The increase in fuel pressure applies a force that unseats the poppet 184. Fuel flows through the opening created between the nozzle housing 180 and the poppet 184 when the poppet 184 is unseated. As the fluid passes through this ring-shaped flow area, a thin conic-shaped sheet of the fluid disperses from the nozzle 106 and atomizes into a conic-shaped spray (e.g., fuel spray 66) having a ring-shaped cross-section, as discussed below. The pump-nozzle assembly 100 may be coupled to a cylinder head 190, such as the head 38 illustrated in FIG. 2, via male/female threads, a flange assembly, or any other suitable mechanical coupling. Thus, the fuel spray from the nozzle 106 may be injected directly into a cylinder.

When the drive signal or current applied to the coil 126 is removed, the drive section 102 will no longer drive the armature 148 towards alignment with the reluctance gap spacer 134, ending the discharging phase and beginning a subsequent charging phase. The spring 152 will reverse the direction of motion of the armature 148 and guide tube 146 away from the reluctance gap spacer 134. Retraction of the guide tube from the pump chamber 120 causes a drop in the pressure within the pump chamber, allowing the outlet check valve assembly 170 to seat. The poppet 184 similarly retracts and seats, and the spray of fuel into the cylinder is interrupted. Following additional retraction of the guide tube, the inlet check valve assembly 156 will unseat and fuel will flow into the pump chamber 120 from the inlet 112. Thus, the operating cycle the pump-nozzle assembly 100 returns to the condition shown in FIG. 4.

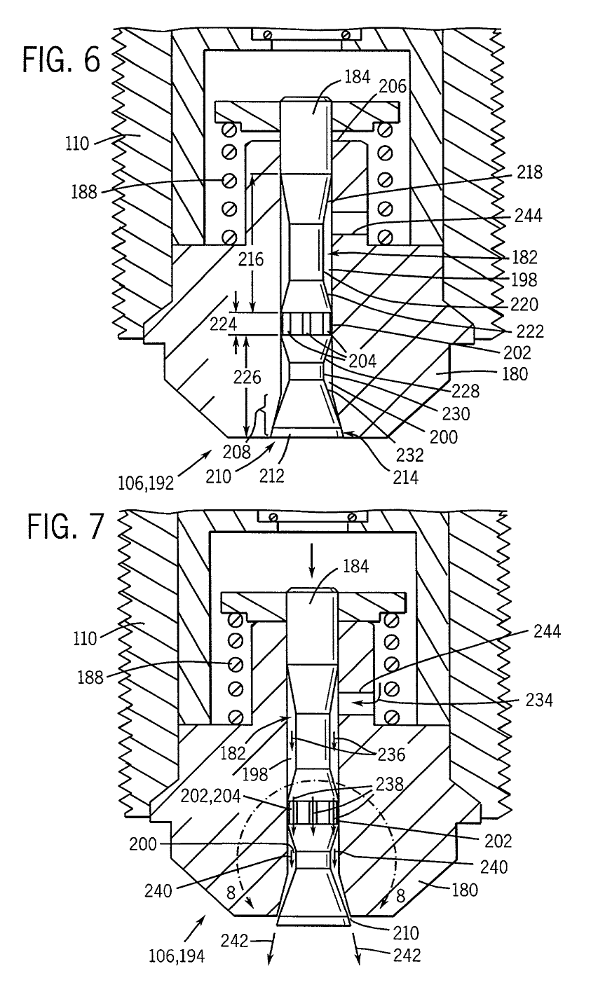

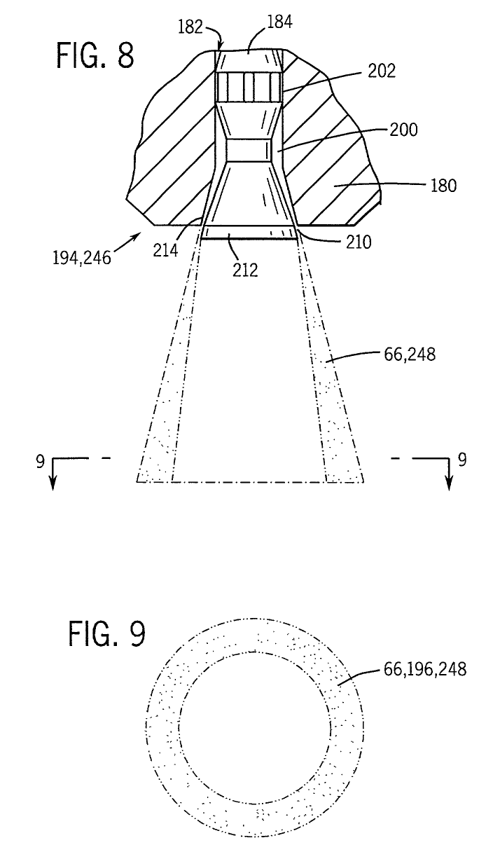

A detailed illustration of the nozzle 106 is provided in FIGS. 6-8, which are side views of the nozzle 106 illustrating exemplary geometries of the passage 182, the poppet 184 and fluid flows through the nozzle 106. FIG. 6 illustrates the nozzle 106 in a closed configuration 192, as illustrated in FIG. 4. FIGS. 7 and 8 illustrate the nozzle 106 in an open configuration 194, as illustrated in FIG. 5. As discussed below, the configuration and geometries of the passage 182 and the poppet 184 facilitate desired fluid flow and spray characteristics, such as dampening fluid flow variances developing upstream, homogenizing the fluid flow adjacent an exit of the nozzle 106, and providing a uniform distribution of droplets throughout a spray cross section 196, as illustrated in FIG. 9.

As illustrated in FIG. 6, the nozzle 106 has the poppet 184 movably disposed within the passage 182 to control fluid flow through the nozzle. The geometries of the passage 182 and the poppet 184 also define symmetrical cavities (e.g., cavities having ring-shaped cross-sections), which are configured to facilitate desired fluid flow characteristics as the drive section 102 is activated and fluid is pressurably passed through the outlet check valve assembly 170 and into the nozzle 106. The geometries of the passage 182 and the poppet 184 form a rear cavity 198 and a forward cavity 200 disposed about a guide area 202, which has a set of passages 204 disposed between the poppet 184 and the passage 182. The passage 182 has a uniform cross section extending from a rear 206 of the nozzle housing 180 to an expanding section 208 of the passage 182 adjacent an exit 210 of the nozzle 106. In this closed configuration 192, a seat portion 212 of the poppet 184 is seated against a seat portion 214 of the expanding section 208. The poppet 184 also has a variety of geometries configured to facilitate flow through the passage 182. Accordingly, the rear cavity 198 has a length 216, which has a contracting portion 218, followed by a central portion 220, and an expanding portion 222. The guide area 202 has a length 224 and has the set of passages 204 disposed about the guide area 202 in an equally spaced manner to provide a more uniform flow distribution into the forward cavity 200. The forward cavity 200 has a length 226, which has a contracting portion 228 adjacent the guide area 202, followed by a central portion 230, and an expanding portion 232 adjacent the seat portion 212. Any suitable angles may be utilized for the expanding portions 222 and 232 and for the contracting portions 218 and 228, while the central portions 220 and 230 may have a uniform cross section.

As illustrated, the contracting portions 218 and 228 and the expanding portions 222 and 232 have conical geometries to facilitate a more uniform flow. However, it should be noted that any other suitable geometry may be utilized within the scope of the present technique. For example, the contracting portion 218 and 228, the central portions 220 and 230, and the expanding portions 222 and 232 may comprise a variety of conic, curved or other suitable geometries to facilitate the desired flow characteristics. However, the lengths 216, 224, and 226 and the corresponding volumes of the rear cavity 198, the set of passages 204, and the forward cavity 200 are configured to provide a more uniform flow of fuel passing through the nozzle 106.

In particular, the forward cavity 200 has a volume and geometry configured to slow the fluid flow, dampen fluid flow variations developing upstream (e.g., in the guide area 202), and homogenize the fluid flow before spray formation at the exit of the nozzle 106. In an exemplary embodiment of the present technique, the forward cavity 200 has a volume that is sufficiently large to act as an abyss, or a stagnant fluid supply, for the fluid ejected from the nozzle 106 during each pulse of the pump-nozzle assembly 100. Although the ejected fluid volume may vary according to pulse time periods and other factors, the volume of the forward cavity 200 may be formed sufficiently large to fully supply fluid for a fluid injection pulse over a full range of operating conditions for the pump-nozzle assembly 100. Accordingly, each pulse of the pump-nozzle assembly 100 would eject all or part of the fluid in the forward cavity 200. In combination or individually, the relatively large volume of the forward cavity 200 and the foregoing volume correlation between the forward cavity 200 and the fluid injection pulse provide a substantially homogenous fluid flow adjacent the exit of the nozzle 106.

FIG. 7 illustrates an exemplary fluid flow pattern through the nozzle 106. In the open configuration 194, fluid flows through the nozzle 106 according to arrows 234, 236, 238, 240, and 242, which correspond to fluid flow through an inlet 244, the rear cavity 198, the set of passages 204, the forward cavity 200, and the exit 210. It should be noted that the guide area 202 is provided to facilitate movement of the poppet 184 through the passage 182, while the set of passages 204 are provided to allow fluid flow between the rear cavity 198 and the forward cavity 200. However, this configuration of multiple distinct passages 204 causes a distribution of the fluid flow corresponding to those multiple distinct passages 204. Accordingly, the present technique provides a relatively short length 224 of the guide area 202 to minimize the effects of these multiple distinct passages 204. The present technique also provides a relatively long length 226 and large volume of the forward cavity 200 to dampen the effects of the multiple distinct passages 204 and to provide a uniform flow prior to spray formation as the fluid exits the nozzle 106 at the exit 210. Accordingly, the lengths 216, 224, and 226 are configured to provide a larger volume forward of the guide area 202 to provide maximum dampening of fluid flow variances and to provide a more uniform spray pattern exiting from the nozzle 106, as illustrated in FIG. 9.

FIG. 8 is a side view of a forward section 246 of the nozzle 106 illustrating the relatively small guide area 202, the relatively large forward cavity 200, and the corresponding spray formed by the nozzle 106. As illustrated, the nozzle 106 forms a hollow spray 248, which has the spray cross-section 196 illustrated in FIG. 9. The hollow spray 248 may have various geometries and dispersion rates depending on the angles of the poppet 184 and the central passage 182, as well as the fluid pressure and flow enhancement effects of the forward cavity 200. Accordingly, the hollow spray 248 has a relatively uniform distribution of droplets, because the forward cavity 200 homogenizes the fluid flow prior to dispersion through the exit 210.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A nozzle comprising:
a conduit having an inlet and an exit; and
an outwardly opening poppet movably disposed in the conduit, comprising:
a first section adjacent the inlet and forming a first cavity between the poppet and the conduit;
a second section adjacent the exit and forming a second cavity between the poppet and the conduit, wherein the second cavity has a desired volume geometry configured for dampening fluid flow variances; and
a guide section disposed between the first and second sections and having at least one passageway coupling the first and second cavities.

2. The nozzle of claim 1, wherein the inlet is disposed laterally to the conduit.

3. The nozzle of claim 1, wherein the inlet is disposed lengthwise with the conduit.

4. The nozzle of claim 1, comprising a plurality of inlets.

5. The nozzle of claim 1, wherein at least a portion of the conduit has a cylindrical cross section.

6. The nozzle of claim 5, wherein the conduit has an outwardly expanding section adjacent the exit.

7. The nozzle of claim 6, wherein the outwardly opening poppet is movable to an open position forming a ring-shaped passage between the conduit and the outwardly opening poppet.

8. The nozzle of claim 6, wherein the outwardly opening poppet has a seat section that is movable to a closed position between the conduit and the outwardly opening poppet.

9. The nozzle of claim 8, comprising a spring assembly coupled to the outwardly opening poppet for biasing the outwardly opening poppet inwardly toward the closed position.

10. The nozzle of claim 1, comprising a pump assembly for feeding fluid into the first cavity through the inlet.

11. The nozzle of claim 10, wherein the pump assembly comprises a linear drive assembly.

12. The nozzle of claim 1, wherein the guide section has a plurality of passageways coupling the first and second cavities.

13. The nozzle of claim 12, wherein the plurality of passageways are disposed symmetrically about the circumference of the outwardly opening poppet.

14. The nozzle of claim 12, wherein the desired volume geometry is configured for dispersing fluid flows passing through the plurality of passageways.

15. The nozzle of claim 1, wherein the desired volume geometry is configured for homogenizing a fluid spray formed at the exit between the conduit and the outwardly opening poppet in an open position.

16. The nozzle of claim 15, wherein the fluid spray comprises a substantially conical spray pattern having a substantially uniform distribution of droplets throughout a cross-section of the substantially conical spray pattern.

17. A uniform spray system, comprising:
an outwardly opening nozzle assembly comprising a forward chamber adjacent a nozzle exit, wherein the forward chamber has a flow homogenizing geometry configured for dampening fluid flow variances to form a substantially uniform spray at the nozzle exit.

18. The uniform spray system of claim 17, wherein the substantially uniform spray has a ring-shaped cross-section.

19. The uniform spray system of claim 17, wherein the outwardly opening nozzle assembly comprises a poppet movably disposed in a fluid passage, the poppet having a forward section forming the forward chamber between the poppet and the fluid passage.

20. The uniform spray system of claim 19, wherein the poppet has a substantially conical head section adjacent the nozzle exit.

21. The uniform spray system of claim 19, wherein the poppet has a plurality of fluid channels disposed symmetrically about the poppet and coupled to an upstream fluid source.

22. The uniform spray system of claim 19, wherein the poppet has a fluid channel coupling the forward chamber to an upstream fluid source.

23. The uniform spray system of claim 22, wherein the fluid channel extends to a rear section of the poppet, the rear section forming a rear chamber between the poppet and the fluid passage.

24. The uniform spray system of claim 22, comprising a pump assembly coupled to the upstream fluid source.

25. The uniform spray system of claim 24, wherein the pump assembly is configured to feed fluid pulsatingly to the outwardly opening nozzle assembly.

26. A combustion engine, comprising:
a combustion chamber;
an ignition assembly coupled to the combustion chamber; and
a spray assembly coupled to the combustion chamber, comprising:
an outwardly opening nozzle assembly comprising a flow homogenizing chamber configured for dampening upstream fuel flow variances to provide a substantially uniform spray; and
a fuel delivery assembly coupled to the outwardly opening nozzle assembly.

27. The combustion engine of claim 26, wherein the outwardly opening nozzle comprises a poppet movably disposed in a fuel passage, the poppet having a forward section forming the flow homogenizing chamber between the poppet and the fuel passage.

28. The combustion engine of claim 27, wherein the poppet has a fuel channel coupling the flow homogenizing chamber to an upstream fuel source.

29. The combustion engine of claim 28, wherein the fuel delivery assembly comprises a pump assembly coupled to the upstream fuel source.

30. The combustion engine of claim 29, wherein the pump assembly is configured to feed fuel pulsatingly through the fuel channel.

31. The combustion engine of claim 28, wherein the fuel channel extends to a rear section of the poppet, the rear section forming a rear chamber between the poppet and the fuel passage.

32. The combustion engine of claim 31, wherein the poppet has a guide section disposed between the forward and rear sections, the guide section having a plurality of fuel channels disposed symmetrically about the poppet and coupling the flow homogenizing chamber to the rear chamber.

33. The combustion engine of claim 32, wherein the substantially uniform spray comprises a conical pattern having a substantially uniform distribution of droplets throughout a cross-section of the conical pattern.

34. A method for homogenizing a spray from an outwardly opening nozzle assembly, comprising:
passing fluid through a flow homogenizing chamber of an outwardly opening nozzle assembly to dampen fluid flow variances and provide a substantially uniform spray.

35. The method of claim 34, wherein passing fluid through a flow homogenizing chamber of the outwardly opening nozzle assembly comprises manipulating a poppet between seated and unseated positions in a passage and, wherein the flow homogenizing chamber is formed between the passage and the poppet at a position adjacent an exit of the outwardly opening nozzle assembly.

36. The method of claim 34, wherein passing fluid through the flow homogenizing chamber comprises homogenizing flow of the fluid adjacent an exit of the outwardly opening nozzle assembly.

37. The method of claim 36, wherein passing fluid through the flow homogenizing chamber comprises uniformly flowing the fluid through the exit.

38. The method of claim 37, comprising forming a conical spray having a substantially uniform distribution of droplets throughout a cross-section of the conical spray.

39. The method of claim 38, wherein uniformly flowing the fluid through the exit comprises passing the fluid through an outwardly expanding section having a ring-shaped cross-section.

40. The method of claim 38, comprising pumping fluid to the outwardly opening nozzle assembly.

41. The method of claim 38, comprising pulsatingly feeding the fluid to the outwardly opening nozzle assembly.

42. The method of claim 38, comprising drawing the fluid from a fuel source.

43. The method of claim 38, wherein the outwardly opening nozzle assembly comprises a poppet movably disposed in a passage and, wherein the flow homogenizing chamber is formed between the passage and the poppet at a position adjacent the exit.

44. The method of claim 43, comprising feeding the fluid to the flow homogenizing chamber through a channel extending at least partially through the poppet.

45. The method of claim 44, wherein feeding the fluid comprises passing the fluid through a chamber formed between the passage and the poppet, the chamber being disposed adjacent the flow homogenizing chamber.

46. The method of claim 45, wherein feeding the fluid comprises passing the fluid through a guide section disposed between the chamber and the flow homogenizing chamber.

47. The method of claim 46, wherein passing the fluid through the guide section comprises passing the fluid through a plurality of passageways extending through the guide section.

48. The method of claim 34, wherein passing the fluid comprises pulsing a desired volume of the fluid correlated to a chamber volume of the flow homogenizing chamber.

49. A method of forming a flow homogenizing spray assembly, comprising: forming a flow homogenizing chamber about an outwardly opening poppet of a nozzle assembly.

49. The method of claim 49, wherein forming the flow homogenizing chamber comprises providing a nozzle housing having a central passage for movably supporting the outwardly opening poppet.

51. The method of claim 50, wherein forming the flow homogenizing chamber comprises forming a symmetrical depression about the outwardly opening poppet, the symmetrical depression being coupled to a flow passage extending through the nozzle assembly.

52. The method of claim 51, wherein the symmetrical depression comprises a desired geometry to dampen fluid flow variances.

53. The method of claim 52, wherein the flow homogenizing chamber is disposed adjacent a spray exit of the nozzle assembly.

54. The method of claim 53, comprising coupling a pump assembly to the nozzle assembly.

55. The method of claim 54, comprising coupling a linear electric motor to the pump assembly.

56. The method of claim 55, comprising coupling a spring assembly to the outwardly opening poppet to bias the outwardly opening spray valve inwardly toward a closed position.
